(19) United States
(12) Patent Application Publication
(10) Pub. No.: US 2010/0085520 A1
(43) Pub. Date: Apr. 8, 2010

(54) LIQUID CRYSTAL DISPLAY APPARATUS AND PROCESS FOR MANUFACTURING THE SAME

(76) Inventor: Takashi Katayama, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/526,565

(22) PCT Filed: Nov. 6, 2007
(86) PCT No.: PCT/JP2007/071566

§ 371 Date: Aug. 10, 2009

(30) Foreign Application Priority Data
Feb. 22, 2007 (JP) 2007-042920

(51) Int. Cl. G02F 1/1335; G02F 1/13

(52) U.S. Cl. 349/114; 349/187

(57) ABSTRACT

A liquid crystal display apparatus that suppresses an increase in a manufacturing cost and is capable of similar display in a reflective region and a transmissive region. The thickness of a liquid crystal layer in the reflection region is in the range of 90% to 110% of that of the liquid crystal layer in the transmissive region, and a pretilt angle of liquid crystal molecules contained in the liquid crystal layer in the reflection region is larger than that of liquid crystal molecules contained in the liquid crystal layer in the transmissive region.

### TECHNICAL FIELD

The present invention relates to a liquid crystal display apparatus, particularly relates to a liquid crystal display apparatus (hereinafter, also referred to as a transflective (transmissive and reflective) liquid crystal display apparatus) which employs an OCB mode (Optically Self-Compensated Birefringence mode) and is capable of display in a transmissive mode and a reflective mode, and also relates to a method of manufacturing the same.

### BACKGROUND ART

A liquid crystal display apparatus has advantages that it has a thinner thickness and a lighter weight, it is drivable with a lower voltage, and it consumes less power, compared with a CRT (Cathode Ray Tube) based display device. On this account, the liquid crystal display apparatus is used in various electronic apparatuses such as a television, a laptop PC (Personal Computer), a desktop PC, a PDA (Personal Digital Assistant), and a mobile phone.

A so-called transflective liquid crystal display apparatus (a liquid crystal display apparatus capable of display in a transmissive mode and a reflective mode) has two display modes, that is, a transmissive mode and a reflective mode, and is capable of turning off its backlight according to brightness of the surroundings. Therefore, among the above-mentioned electronic apparatuses, the transflective liquid crystal display apparatus is suitable for use requiring less power consumption, for example, for a portable information terminal (such as the mobile phone) use.

On the other hand, now that displaying a moving image by means of a liquid crystal panel (e.g., a television) is rapidly spreading, there is an increasing demand for a liquid crystal panel having an increased response speed and displaying a moving image favorably. In view of this, recently, attention is particularly focused on an OCB mode, which has a high response speed.

In the OCB mode, (i) liquid crystal molecules are sandwiched between two substrates having been subjected to an alignment process by which the liquid crystal molecules are aligned with a slope, in parallel, and along the same direction, (ii) surfaces of the substrates are provided with wave plates, respectively, and (iii) polarizing plates are provided on both of the substrates such that the polarizing plates are arranged in crossed Nicols. The wave plate is, for example, a negative wave plate whose principal axis has a hybrid alignment.

FIG. 9 and FIG. 10 are cross-section views schematically illustrating a configuration of a conventional liquid crystal display apparatus 101 employing the OCB mode. FIG. 9 illustrates an orientation of liquid crystal molecules 190 while no voltage is applied, and FIG. 10 illustrates an orientation of the liquid crystal molecules 190 while a voltage is being applied.

As illustrated in FIG. 9 and FIG. 10, in the liquid crystal display apparatus 101 employing the OCB mode, the liquid crystal molecules 190 are aligned in a splay alignment as shown in FIG. 9 while no voltage is applied, and applying voltage causes the liquid crystal molecules 190 to transition to a bend alignment as shown in FIG. 10 (splay-bend transition). Display is carried out with the bend alignment.

As illustrated in FIG. 9 and FIG. 10, a liquid crystal panel 105 of the liquid crystal display apparatus 101 includes a TFT substrate 141 and a counter substrate 142. The TFT substrate 141 contains a first glass substrate 151 on which (a) a wiring layer 134 provided with a TFT (Thin Film Transistor), (b) an insulating layer 126, (c) a pixel electrode 122, and (d) an alignment layer 157 are formed. The counter substrate 142 contains a second glass substrate 152 on which (a) a color filter (not illustrated), (b) a counter electrode 156, and (b) an alignment layer 157 are formed. Further, the liquid crystal panel 105 includes a liquid crystal layer 155 sandwiched between the TFT substrate 141 and the counter substrate 142, the liquid crystal layer 155 containing the liquid crystal molecules 190.

The following describes a conventional art related to a transflective liquid crystal display apparatus to which the OCB mode is applied.

Firstly, a configuration of a conventional, generally-used transflective liquid crystal display apparatus is described. FIG. 11 is a cross-section view schematically illustrating a configuration of a conventional transflective liquid crystal display apparatus 101.

As illustrated in FIG. 11, the liquid crystal display apparatus 101 includes (i) a liquid crystal panel 105 and (ii) a light source section 181 provided behind the liquid crystal panel 105. The light source section 181 includes a light source 182 and a light guide plate 183.

The liquid crystal panel 105 includes a TFT substrate 141 and a counter substrate 142, and a liquid crystal layer 155 sandwiched between the TFT substrate 141 and the counter substrate 142.

The liquid crystal display apparatus 101, which has a reflective region a serving as a reflective display section and a transmissive region b serving as a transmissive display section, is capable of switching between a transmissive display mode and a reflective display mode by turning on and off the light source section 181 according to brightness of the surroundings.

Further, in the liquid crystal display apparatus 101, a resin step 154 is formed on the counter substrate 142 so that a thickness of the liquid crystal layer 155 in the reflective region a is thinner than a thickness of the liquid crystal layer 155 in the transmissive region b. This causes (i) a light path length in the reflective region a and (ii) a light path length in the transmissive region b to be equalized, the light path length being a distance of light traveling through the liquid crystal layer 155. In the transmissive region b, as indicated by the arrow d, light emitted from the light source section 181 toward the liquid crystal panel 105 passes through the liquid crystal layer 155 only once, and exits from a display surface, so as to carry out display. On the other hand, in the reflective region a, as indicated by the arrow c, light entering the display surface from an observer e side passes through the liquid crystal layer 155 via the resin step 154, and is reflected by a pixel electrode 122. Then, the light passes through the liquid crystal layer 155 again, and exits from the display surface via the resin step 154, so as to carry out display.

Here, a height of the resin step 154 is set to approximately half a thickness of the liquid crystal layer 155 in the transmissive region b, for the purpose of causing (i) the light path length of light transmitting through the liquid crystal layer 155 in the reflective region a and (ii) that in the transmissive region b to be equalized.

As well as a conventional liquid crystal display apparatus, the liquid crystal display apparatus 101 is arranged such that (i) the TFT substrate 141 includes the pixel electrode 122 and the counter substrate 142 includes a counter electrode 156, and (ii) a wave plate 162 and a polarizing plate 161 are attached on each of outer surfaces of the TFT substrate 141 and the counter substrate 142.

Next, the following describes a technique of a conventional transflective liquid crystal display apparatus in which OCB mode liquid crystal is used. Patent Literature 1 discloses a technique related to a conventional transflective liquid crystal display apparatus 101 in which the OCB mode liquid crystal is used. FIG. 12 is a cross-section view schematically illustrating a configuration of the liquid crystal display apparatus 101 disclosed in Patent Literature 1.

As illustrated in FIG. 12, in a reflective region a of the liquid crystal display apparatus 101, a resin step 154 is provided so as to cause (i) a light path length in a reflective region a and (ii) a light path length in a transmissive region b to be equalized, as well as in the liquid crystal display apparatus 101 illustrated in FIG. 11.

Liquid crystal molecules 190 in the transmissive region b (a region f in FIG. 12) are aligned in the bend alignment (a horizontal alignment both on a counter electrode 156 side and, a reflective electrode 122a side).

On the other hand, liquid crystal molecules 190 in the reflective region a (a region g in FIG. 12) are aligned such that the alignment of the liquid crystal molecules 190 in the transmissive region b is cut right in half. In other words, in the reflective region a, the liquid crystal molecules 190 in an area contacting the reflective electrode 122a are aligned in a vertical alignment (a vertical alignment with respect to one substrate, a horizontal alignment with respect to the other substrate: a hybrid alignment).

As described above, the transflective liquid crystal display apparatus disclosed in Patent Literature 1 has a cell gap configuration (step configuration) in which the thickness of the liquid crystal layer 155 in the reflective region a is different from that in the transmissive region b, and has the liquid crystal molecules 190 whose alignment in the reflective region a is different from that in the transmissive region b.

### Citation List

Patent Literature 1

Japanese Patent Application Publication, Tokukai, No. 2005-84593 (Publication Date: Mar. 31, 2005)

Patent Literature 2

Japanese Patent Application Publication, Tokukai, No. 2002-207206 (Publication Date: Jul. 26, 2002)

Patent Literature 3

Japanese Patent Application Publication, Tokukai, No. 2002-350902 (Publication Date: Dec. 4, 2002)

Patent Literature 4

Japanese Patent Application Publication, Tokukai, No. 2005-31680 (Publication Date: Feb. 3, 2005)

Patent Literature 5

Japanese Patent Application Publication, Tokukai, No. 2003-107531 (Publication Date: Apr. 9, 2003), Japanese Patent No. 3334714

Patent Literature 6

Japanese Patent Application Publication, Tokukai, No. 2002-311456 (Publication Date: Oct. 23, 2002)

### SUMMARY OF INVENTION

The conventional transflective liquid crystal display apparatus, however, needs to be provided with a step for making the thickness of the liquid crystal layer in the reflective region different from that in the transmissive region. This causes such a problem that the provision of the step increases a manufacturing cost.

Further, with the configuration disclosed in Patent Literature 1, it is difficult to apply completely different alignment processes (i.e., an alignment process for a horizontal alignment and an alignment process for a vertical alignment) to the reflective region and the transmissive region, respectively. Therefore, there has been such a problem that it is not easy to manufacture an actual product by using the configuration disclosed in Patent Literature 1.

In view of this, in order to overcome the difficulty, such a configuration is considered that both of the reflective region and the transmissive region have the OCB mode, that is, the bend alignment.

However, in order to realize the bend alignment, an alignment transition from the splay alignment to the bend alignment is necessary. Generally, this alignment transition is not easily carried out, and it is necessary to generate a transition nucleus in order to carry out the alignment transition surely.

With regard to this, as a technique for generating the transition nucleus, such a technique is proposed that a nucleus for causing the transition to the bend alignment is generated by utilizing a lateral electric field or by making a hole on a pixel electrode. For example, Patent Literature 2 proposes a technique for generating a lateral electric field between a signal line and a pixel electrode, Patent Literature 3 proposes a technique for providing a wiring electrode between pixel electrodes for the purpose of strengthening a lateral electric field, Patent Literature 4 proposes a technique for providing a metal electrode for the purpose of causing a bend alignment in a pixel, and Patent Literature 5 proposes a technique for forming a lacked section in a pixel electrode for the purpose of generating a lateral electric field.

Further, it is known that spreading of the bend alignment is generally difficult to go over a step.

Therefore, in a case where the OCB mode is employed both in a reflective region and a transmissive region of a transflective liquid crystal display apparatus in which a resin step is provided in the reflective region (i.e., a liquid crystal display apparatus in which a thickness of a liquid crystal layer in the reflective region is different from that in the transmissive region), both of the reflective region and the transmissive region need to be provided with means for generating a transition nucleus, for the purpose of carrying out a splay-bend transition surely in a short period of time.

The following describes an example of a liquid crystal display apparatus 101, which is the transflective liquid crystal display apparatus provided with the resin step and further provided with the means for generating the transition nucleus both in the reflective region and the transmissive region.

Firstly, the following describes, with reference to FIG. 13 and FIG. 14, a liquid crystal display apparatus 101 in which a lacked section 112a is provided on a pixel electrode 122 for the purpose of generating a lateral electric field. FIG. 13 is a plan view schematically illustrating a configuration of one pixel on a TFT substrate 141 in the liquid crystal display apparatus 101 to which the technique for providing the lacked section 112a on the pixel electrode 122 is applied. FIG. 14 is a cross-section view schematically illustrating a cross-section configuration of a liquid crystal panel 105 of the liquid crystal display apparatus 101 viewed in a case where the liquid crystal display apparatus 101 is cut along a line corresponding to the R-R line in FIG. 13, and illustrates the cross-section configuration of the liquid crystal panel 105 and an alignment of liquid crystal molecules 190.

As illustrated in FIG. 13 and FIG. 14, in the TFT substrate 141, the lacked sections 112a serving as the means for generating the nucleus are provided on a reflective electrode 122a in a reflective region a and a transparent electrode 122b in a transmissive region b, respectively. A common electrode 124 is formed in a layer under the lacked sections 112a via an insulating layer 126 so as to be parallel to a gate bus line 131.

Thereby, as indicated by equipotential lines x in FIG. 14, a lateral electric field is generated in the vicinity of the lacked section 112a, so that the nucleus (transition nucleus) for the bend alignment is formed.

The gate bus line 131 and a data bus line 132 are connected with the pixel electrode 122 via a TFT (not illustrated).

Next, the following describes, with reference to FIG. 15 and FIG. 16, a liquid crystal display apparatus 101 in which a protruded section 112b serving as the means for generating the nucleus is provided on a pixel electrode 122, instead, of the lacked section 112a. FIG. 15 is a plan view schematically illustrating a configuration of one pixel on a TFT substrate 141 in the liquid crystal display apparatus 101 to which the technique for providing the protruded section 112b on the pixel electrode 122 is applied. FIG. 16 is a cross-section view schematically illustrating a cross-section configuration of a liquid crystal panel 105 of the liquid crystal display apparatus 101 viewed in a case where the liquid crystal display apparatus 101 is cut along a line corresponding to the S-S line in FIG. 15, and illustrates the cross-section configuration of the liquid crystal panel 105 and an alignment of liquid crystal molecules 190.

As illustrated in FIG. 15 and FIG. 16, in the liquid crystal display apparatus 101, the protruded sections 112b serving as the means for generating the nucleus are provided on a reflective electrode 122a in a reflective region a and a transparent electrode 122b in a transmissive region b, respectively. Thereby, the nucleuses (transition nucleuses) for the bend alignment are formed in the vicinity of the protruded sections 112b.

(Reduction in Transmittance and Reflectance)

However, both the configuration including the lacked section 112a and the configuration including the protruded section 112b have such a problem that these configurations lead to a reduction in a transmittance and a reflectance, thereby causing darker display.

That is, as for the lacked section 112a provided on the pixel electrode 122, it is impossible to drive the liquid crystal molecules 190 above the lacked section 112a. Therefore, the liquid crystal molecules 190 above the lacked section 112a cannot contribute to light transmission or light reflection.

Further, as for the protruded section 112b, a thickness of the liquid crystal layer 155 above the protruded section 112b is reduced, and this leads to a reduction in a retardation. Therefore, the liquid crystal molecules 190 above the protruded section 112b cannot contribute to light transmission or light reflection.

Further, as described above, the transflective liquid crystal display apparatus including the step needs to be provided with two lacked sections 112a or two protruded sections 112b in one pixel. This leads to a further reduction in display brightness.

(Difficulty in Bend Transition)

The means for generating the transition nucleus by using a structure such as the lacked section 112a and the protruded section 112b is, as a source for causing the bend alignment, a point. Therefore, with this means, it is difficult to carry out the splay-bend transition surely in a short period of time.

Further, in order to carry out the splay-bend transition surely, it is necessary to generate a plurality of transition nucleuses in one pixel, and accordingly it is necessary to provide a plurality of means for generating nucleus. Such a configuration leads to a further reduction in display brightness.

(Inverse Transition)

For example, in a case where the OCB mode, employing normally white, is used, a voltage applied to a liquid crystal layer needs to be reduced to near a critical voltage (Vcr) between the splay alignment and the bend alignment, for the purpose of carrying out a white display having a high transmittance. Therefore, in a case where a white display is carried out, a transition (inverse transition) from the bend alignment to the splay alignment may occur, thereby preventing proper display.

In other words, in order to prevent the inverse transition in the OCB mode, it is preferable that the voltage applied to the liquid crystal layer is higher than the Vcr. However, there is trade-off between (i) a margin of the voltage from the Vcr (a difference between the voltages) and (ii) a transmittance in a white display. For this reason, in a case where the voltage applied to the liquid crystal layer is set to near the Vcr for the purpose of carrying out a bright white display, the inverse transition is apt to occur.

The following techniques are proposed as a method for preventing the inverse transition: (i) a technique for inserting black once or more in one frame for the purpose of stably maintaining the bend alignment; and (ii) a technique for additionally providing an electrode in a non-visible region around a visible region for the purpose of driving liquid crystal in the non-visible region (Patent Literature 6).

These techniques, however, are not adequate as the method for preventing the inverse transition.

The technique for additionally providing the electrode is such that a voltage is applied to the electrode for the purpose of maintaining a bend-transitioned state while the splay-bend transition is carried out or while an image is displayed. Forming the electrode in a region which is not the visible region and applying a voltage thereto leads to an increase in a manufacturing cost and power consumption.

The present invention was made in view of the foregoing problems, and an objective of the present invention is to provide (i) a transflective liquid crystal display apparatus which does not need a step or the like for making a thickness of a liquid crystal layer in a reflective region different from that in a transmissive region, suppresses an increase in a manufacturing cost, and is capable of similar display in the reflective region and the transmissive region and (ii) a method of manufacturing the transflective liquid crystal display apparatus.

Further, the present invention is for providing a transflective liquid crystal display apparatus which prevents a reduction in a transmittance and a reflectance and allows a bend transition to be carried out easily.

Furthermore, the present invention is for providing a transflective liquid crystal display apparatus capable of suppressing occurrence of an inverse transition while suppressing an increase in a manufacturing cost and power consumption.

In order to solve the foregoing problems, a liquid crystal display apparatus according to the present invention includes: a pair of substrates facing each other; and a liquid crystal layer sandwiched between the pair of substrates, the liquid crystal display apparatus having a reflective region and a transmissive region in each pixel, so as to be capable of display in a transmissive mode and a reflective mode, a thickness of the liquid crystal layer in the reflective region being 90% or more but 110% or less of a thickness of the liquid crystal layer in the transmissive region, and a pretilt angle of liquid crystal molecules contained in the liquid crystal layer in the reflective region being larger than a pretilt angle of liquid crystal molecules contained in the liquid crystal layer in the transmissive region.

Further, in the liquid crystal display apparatus according to the present invention, the thickness of the liquid crystal layer in the reflective region is the same as the thickness of the liquid crystal layer in the reflective region.

With this configuration, because the thickness of the liquid crystal layer in the reflective region is substantially the same or the same as the thickness of the liquid crystal layer in the transmissive region, it is not necessary to provide a structure such as a step for making the thickness of the liquid crystal layer in the reflective region different from that in the transmissive region. This makes it possible to suppress an increase in a manufacturing cost.

Generally, in a liquid crystal display apparatus in which a thickness of a liquid crystal layer in a reflective region is substantially the same or the same as a thickness of the liquid crystal layer in a transmissive region, a brightness of light emitted from the reflective region is different from a brightness of light emitted from the transmissive region. This results from the fact that the light emitted from the transmissive region is emitted after passing through the liquid crystal layer only once, whereas the light emitted from the reflective region is emitted after passing through the liquid crystal layer twice. In other words, this results from a difference in a so-called light path length between transmitted light and reflected light.

In view of this point, in the liquid crystal display apparatus having the foregoing configuration, the pretilt angle in the reflective region is different from the pretilt angle in the transmissive region, and the pretilt angle in the reflective region is larger than the pretilt angle in the transmissive region. This reduces the difference in brightness between the light emitted from the reflective region and the light emitted from the transmissive region, despite the fact that the thickness of the liquid crystal layer in the reflective region is substantially the same or the same as the thickness of the liquid crystal layer in the transmissive region.

Thus, with the foregoing configuration, it is possible to realize a liquid crystal display apparatus which does not need a step or the like for making a thickness of a liquid crystal layer in a reflective region different from that in a transmissive region, suppresses an increase in a manufacturing cost, and is capable of similar display in the reflective region and the transmissive region.

Furthermore, in the liquid crystal display apparatus according to the present invention, a retardation of the liquid crystal layer in the reflective region is 90% or more but 100% or less of a retardation of the liquid crystal layer in the transmissive region. Moreover, in the liquid crystal display apparatus according to the present invention, the retardation of the liquid crystal layer in the reflective region is the same as the retardation of the liquid crystal layer in the transmissive region.

With this configuration, because the retardation of the liquid crystal layer in the reflective region is substantially the same or the same as the retardation of the liquid crystal layer in the transmissive region, it is possible to further reduce a difference in display (such as the difference in brightness) between the reflective region and the transmissive region.

Further, in the liquid crystal display apparatus according to the present invention, each of the pair of substrates is provided with an alignment layer on at least part of a surface of said each of the pair of substrates which surface is in contact with the liquid crystal layer, the alignment layer controlling an alignment of the liquid crystal molecules contained in the liquid crystal layer; and the alignment layer is formed, by polymerizing a polymerization component contained in the liquid crystal layer while a voltage is being applied to the liquid crystal layer.

With this configuration, because the alignment layer is formed by polymerizing the polymerization component contained in the liquid crystal layer, it is possible to form the alignment layer easily.

Further, because the polymerization component is polymerized while the voltage is applied to the liquid crystal layer, it is possible to easily form alignment layers having various alignment control forces by controlling the voltage applied.

Furthermore, because the alignment layer is formed by polymerizing the polymerization component contained in the liquid crystal layer, it is possible to easily form the alignment layer at a desired position on the substrate by adjusting a position to be polymerized.

In this context, the alignment layer only needs to be the one controlling the alignment of the liquid crystal molecules, and is not limited to a film-type one covering the whole of the foregoing surface on the substrate. For example, the alignment layer may be the one discretely formed on the foregoing surface.

Further, in the liquid crystal display apparatus according to the present invention, the alignment layer formed by polymerizing the polymerization component is provided in the reflective region only.

With this configuration, because the alignment layer formed by the polymerization is provided on the reflective region only, it is possible to easily make the pretilt angle in the reflective region larger than the pretilt angle in the transmissive region.

Further, in the liquid crystal display apparatus according to the present invention, during polymerizing of the alignment layer, the voltage applied to the liquid crystal layer in the reflective region is equal to or higher than an ON-voltage applied to the liquid crystal layer in the transmissive region, the ON-voltage being applied while display is actually carried out.

With this configuration, the voltage applied to the liquid crystal layer in the reflective region during the polymerization is equal to or higher than the ON-voltage (e.g., a voltage (black voltage) at which a black display is carried out in a normally white mode) applied to the transmissive region while display is actually carried out. Accordingly, this makes it easy to realize, in the reflective region, display (black display) equal to that in the transmissive region, even if a voltage (black voltage) equal to a voltage applied to the transmissive region is applied to the reflective region in a case of carrying out an ON-display.

Further, in the liquid crystal display apparatus according to the present invention, the liquid crystal molecules contained in the liquid crystal layer in the transmissive region and the reflective region are transitioned from a splay alignment to a bend alignment in response to a voltage applied to the liquid crystal layer.

With this configuration, in the liquid crystal display apparatus employing the OCB mode in which an alignment transition (splay-bend alignment transition) from the splay alignment to the bend alignment occurs in response to application of a voltage to the liquid crystal layer, a region having a larger pretilt angle than that of other regions is provided in one pixel. When a voltage is applied to the liquid crystal layer for the purpose of causing the splay-bend alignment transition in the OCB mode, transition to the bend alignment is more likely to occur in the region having the larger pretilt angle than in other regions having the smaller pretilt angle. Thus, the region having the larger pretilt angle functions as the transition nucleus in a case of the splay-bend alignment transition.

Further, because the region having the larger pretilt angle is provided as the reflective region in the pixel, the region having the larger pretilt angle hardly inhibits display. In other words, unlike the structure such as the lacked section and the protruded section provided for the purpose of generating the transition nucleus, the region having the larger pretilt angle hardly causes a reduction in a transmittance or a reflectance.

Thus, with the foregoing configuration, it is possible to realize a liquid crystal display apparatus which suppresses a reduction in a transmittance or a reflectance and allows the bend transition to be carried out easily.

Further, in the liquid crystal display apparatus according to the present invention, the liquid crystal molecules contained in the liquid crystal layer in the reflective region are aligned in a bend alignment while no voltage is applied to the liquid crystal layer; and the liquid crystal molecules contained in the liquid crystal layer in the transmissive region are transitioned from a splay alignment to the bend alignment in response to a voltage applied to the liquid crystal layer.

With this configuration, because a region where the liquid crystal molecules are aligned in the bend alignment is provided in one pixel, it is possible to easily carry out the splay-bend alignment transition in the liquid crystal display apparatus employing the OCB mode.

Further, as described above, the reflective region where the liquid crystal molecules are aligned in the bend alignment does not inhibit display.

As described above, with the foregoing configuration, it is possible to realize a liquid crystal display apparatus which suppresses a reduction in a transmittance or a reflectance and allows the bend transition to be carried out easily.

Further, in the liquid crystal display apparatus according to the present invention, one of the pair of substrates is provided with a transistor element, one for said each pixel, for switching said each pixel, and is provided with a gate bus line for controlling the transistor element; and the reflective region in said each pixel is provided along the gate bus line for controlling the transistor element provided for said each pixel.

Furthermore, in the liquid crystal display apparatus according to the present invention, said each pixel is shaped in a rectangle; the gate bus line is parallel to two sides of said each pixel shaped in the rectangle, the two sides being opposed to each other; and the reflective region in said each pixel is provided along at least the two sides parallel to the gate bus line, out of four sides of said each pixel shaped in the rectangle.

Moreover, in the liquid crystal display apparatus according to the present invention, said each pixel is shaped in a rectangle; and the reflective region, shaped in a frame, is provided along four sides of said each pixel shaped in the rectangle.

With this configuration, it is possible to effectively prevent occurrence of the inverse transition, which is a transition from the bend alignment to the splay alignment, in the liquid crystal display apparatus employing the OCB mode. This is described below.

Generally, the inverse transition is apt to occur from an area around a pixel, for example, a corner of the pixel and an area around a wiring line such as a gate bus line. This is because, for example, the splay alignment is apt to remain around a spacer on a TFT which spacer is provided at the corner of the pixel, and the inverse transition is apt to occur from the area where the splay alignment remains. Another reason for this is that the inverse transition is apt to be promoted by a lateral electric field occurring (i) between a pixel electrode provided on a pixel and a gate bus line or (ii) between pixel electrodes adjacent to each other.

In view of this point, with the foregoing configuration, (i) the region having the larger pretilt angle than that of other regions in the pixel or (ii) the region where the liquid crystal molecules are aligned in the bend alignment while no voltage is applied is provided in an area along the gate bus line or an area along the four sides of the pixel, in both of which areas the inverse transition is apt to occur. In addition, as described above, the bend alignment in the region having the larger pretilt angle is more stable than in other regions.

The foregoing configuration is not such that an electrode is additionally formed in a region which is not a visible region and a voltage is applied to the electrode, the voltage being not directly related to display.

Thus, with the foregoing configuration, it is possible to realize a liquid crystal display apparatus which suppresses occurrence of the inverse transition while suppressing an increase in a manufacturing cost and power consumption.

In order to solve the foregoing problems, a method of manufacturing a liquid crystal display apparatus according to the present invention, said apparatus including a pair of substrates facing each other and a liquid crystal layer sandwiched between the pair of substrates, said apparatus having a reflective region and a transmissive region in each pixel, so as to be capable of display in a transmissive mode and a reflective mode, a thickness of the liquid crystal layer in the reflective region being 90% or more but 110% or less of a thickness of the liquid crystal layer in the transmissive layer, includes the step of: polymerizing a polymerization component, among polymerization components added to the liquid crystal layer, added to the liquid crystal layer in the reflective region while a voltage is being applied to the liquid crystal layer so that a pretilt angle of liquid crystal molecules contained in the liquid crystal layer in the reflective region is larger than a pretilt angle of liquid crystal molecules contained in the liquid crystal layer in the transmissive region.

According to this method, because the thickness of the liquid crystal layer in the reflective region is substantially the same as the thickness of the liquid crystal layer in the transmissive region, it is not necessary to provide the structure such as the step for making the thickness of the liquid crystal layer in the reflective region different from that in the transmissive region. This makes it possible to suppress an increase in a manufacturing cost.

Further, according to the foregoing method, the pretilt angle in the reflective region is larger than the pretilt angle in the transmissive region. This reduces the difference in brightness between the light emitted from the reflective region and the light emitted from the transmissive region, despite the fact that there is a difference in the light path length between the transmitted light and the reflected light.

Thus, according to the foregoing method of manufacturing the liquid crystal display apparatus, it is possible to realize a method of manufacturing a liquid crystal display apparatus which does not need a step or the like for making a thickness of a liquid crystal layer in a reflective region different from that in a transmissive region, suppresses an increase in a manufacturing cost, and is capable of similar display in the reflective region and the transmissive region.

As described above, in a liquid crystal display apparatus according to the present invention, a thickness of the liquid crystal layer in the reflective region is 90% or more but 110% or less of a thickness of the liquid crystal layer in the transmissive region, and a pretilt angle of liquid crystal molecules contained in the liquid crystal layer in the reflective region is larger than a pretilt angle of liquid crystal molecules contained in the liquid crystal layer in the transmissive region.

Further, as described above, with a method of manufacturing a liquid crystal display apparatus according to the present invention, only a polymerization component, among polymerization components added to the liquid crystal layer, added to the liquid crystal layer in the reflective region is polymerized while a voltage is being applied to the liquid crystal layer, so that a pretilt angle of liquid crystal molecules contained in the liquid crystal layer in the reflective region is larger than a pretilt angle of liquid crystal molecules contained in the liquid crystal layer in the transmissive region.

Accordingly, it is possible to attain the following effects: (i) a step or the like for making a thickness of a liquid crystal layer in a reflective region different from that in a transmissive region is not necessary, (ii) an increase in a manufacturing cost is suppressed, and (iii) similar display in the reflective region and the transmissive region is possible.

Further, it is possible to realize (i) a liquid crystal display apparatus which does not need a step or the like for making a thickness of a liquid crystal layer in a reflective region different from that in a transmissive region, suppresses an increase in a manufacturing cost, and is capable of similar display in the reflective region and the transmissive region and (ii) and a method of manufacturing the liquid crystal display apparatus.

### BRIEF DESCRIPTION OF DRAWINGS

FIG. 1, relating to an embodiment of the present invention, is a view schematically illustrating a configuration of a liquid crystal display apparatus.

FIG. 2 is a cross-section view of the liquid crystal display apparatus, along a line corresponding to the O-O line in FIG. 1.

FIG. 3 is a view illustrating an electro-optical property of the liquid crystal display apparatus according to the present invention.

FIG. 4, relating to another embodiment of the present invention, is a view schematically illustrating a configuration of a liquid crystal display apparatus.

FIG. 5 is a cross-section view of the liquid crystal display apparatus, along a line corresponding to the P-P line in FIG. 4.

FIG. 6, relating to further another embodiment of the present invention, is a view schematically illustrating a configuration of a liquid crystal display apparatus.

FIG. 7 is a cross-section view of a liquid crystal display apparatus, along a line corresponding to the Q-Q line in FIG. 6.

FIG. 8 is a view illustrating a relationship between a polymerization voltage and a pretilt angle in the present invention.

FIG. 9, relating to a conventional art, is a cross-section view schematically illustrating a configuration of a liquid crystal display apparatus employing an OCB mode.

FIG. 10, relating to the conventional art, is a cross-section view schematically illustrating the configuration of the liquid crystal display apparatus employing the OCB mode.

FIG. 11, relating to a conventional art, is a cross-section view schematically illustrating a configuration of a liquid crystal display apparatus.

FIG. 12, relating to a conventional art, is a cross-section view schematically illustrating a configuration of a liquid crystal display apparatus.

FIG. 13 is a plan view schematically illustrating a configuration of a liquid crystal display apparatus including a pixel electrode provided with a lacked section.

FIG. 14 is a cross-section view of the liquid crystal display apparatus, along a line corresponding to the R-R line in FIG. 13.

FIG. 15 is a plan view schematically illustrating a configuration of a liquid crystal display apparatus including a pixel electrode provided with a protruded section.

FIG. 16 is a cross-section view of the liquid crystal display apparatus, along a line corresponding to the S-S line in FIG. 15.

### REFERENCE SIGNS LIST

1 liquid crystal display apparatus
5 Liquid crystal panel
11 Pixel
22 Pixel electrode
22a Reflective electrode
22b Transparent electrode
24 Common electrode
26 Insulating layer
31 Gate bus line
32 Data bus line
41 TFT substrate (Substrate)
42 Counter substrate (Substrate)
51 First glass substrate
52 Second glass substrate
55 Liquid crystal layer
56 Counter electrode
57 First alignment layer (Alignment layer)
58a Second alignment layer for reflective region (Alignment Layer)
90 Liquid crystal molecules
101 Liquid crystal display apparatus
105 Liquid crystal panel
112a Lacked section
112b Protruded section
122 Pixel electrode
122a Reflective electrode
122b Transparent electrode
124 Common electrode
126 Insulating layer
131 Gate bus line
132 Data bus line
134 Wiring layer
141 TFT substrate
142 Counter substrate
151 First glass substrate
152 Second glass substrate
154 Resin step
155 Liquid crystal layer
156 Counter electrode
157 Alignment layer
161 Polarizing plate
162 Wave plate
181 Light source section
182 Light source
183 Light guide plate
190 Liquid crystal molecules

### DESCRIPTION OF EMBODIMENTS

### First Embodiment

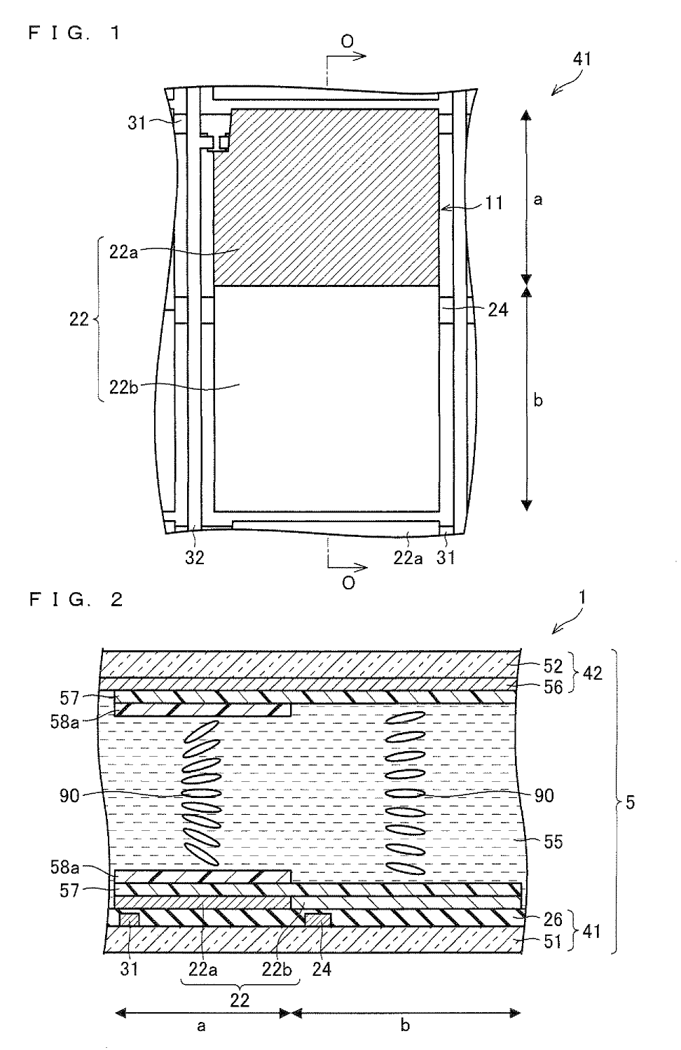

The following describes one embodiment of the present invention with reference to FIG. 1 to FIG. 3.

FIG. 1, relating to the embodiment of the present invention, is a view schematically illustrating a configuration of a liquid crystal display apparatus. FIG. 2 is a cross-section view schematically illustrating a cross-section configuration of a liquid crystal panel 5 of a liquid crystal display apparatus 1 in a case where the liquid crystal display apparatus 1 is cut along a line corresponding to the O-O line in FIG. 1, and illustrates the cross-section configuration of the liquid crystal panel 5 and an alignment of liquid crystal molecules 90.

As illustrated in FIG. 1, a TFT (Thin Film Transistor) substrate 41 in the liquid crystal display apparatus of the present embodiment is provided with a gate bus line 31 and a data bus line 32 intersecting each other via an insulating layer (26 in FIG. 2). Further, a pixel 11 partitioned with the gate bus line 31 and the data bus line 32 is provided with a pixel electrode 22. Here, the pixel electrode 22 is divided into a reflective electrode 22a and a transparent electrode 22b, which correspond to a reflective region a and a transmissive region b, respectively. Further, the gate bus line 31 and the data bus line 32 are connected with the pixel electrode 22 via a TFT (not illustrated) serving as a transistor element.

Furthermore, in a layer including the gate bus line 31, a common electrode 24 is provided so as to be parallel to the gate bus line 31. Further, at a part where the common electrode 24 and the pixel electrode 22 overlap, an intermediate electrode (not illustrated) is provided in a layer including the data bus line 32. This forms an auxiliary capacity between the intermediate electrode and the common electrode 24, thereby stabilizing a potential of the pixel electrode 22.

As illustrated in FIG. 2, the liquid crystal panel 5 of the liquid crystal display apparatus 1 according to the present embodiment includes the TFT substrate 41, a counter substrate 42 positioned so as to be opposed to the TFT substrate 41, and the liquid crystal molecules 90 sealed between the TFT substrate 41 and the counter substrate 42. Here, the counter substrate 42 is provided with a color filter (not illustrated) and a counter electrode 56.

Here, the liquid crystal display apparatus 1 according to the present embodiment is not provided with a resin step, for example, the one illustrated in FIG. 11. Therefore, in the liquid crystal display apparatus 1, a liquid crystal layer 55, sandwiched between the TFT substrate 41 and the counter substrate 42, has substantially the same thicknesses in the reflective region a and the transmissive region b.

Next, the following describes an alignment of the liquid crystal molecules 90 in the liquid crystal display apparatus 1 according to the present embodiment.

As illustrated in FIG. 2, the TFT substrate 41 and the counter substrate 42 are respectively provided with first alignment layers 57 for causing the liquid crystal molecules 90 to be aligned in a splay alignment. The first alignment layers 57 are provided on almost the whole surfaces of the pixel electrode 22 and the counter electrode 56, respectively. The first alignment layer 57 is a horizontal alignment layer for causing the liquid crystal molecules 90 to be aligned in a horizontal direction.

Further, in addition to the first alignment layer 57, a second alignment layer (a second alignment layer 58a for a reflective region) is provided only in a reflective region a in the liquid crystal display apparatus 1 according to the present embodiment. That is, the first alignment layer 57 is provided both in the reflective region a and the transmissive region b, whereas the second alignment layer 58a for the reflective region is provided only in the reflective region a.

Specifically, the second alignment layer for the reflective region is provided only in the reflective region a of the first alignment layer surface of each of the TFT substrate 41 and the counter substrate 42.

Next, the following describes a method for forming the second alignment layer for the reflective region. The second alignment layer for the reflective region is formed such that (i) a polymerization component sealed in advance in the liquid crystal layer 55 together with the liquid crystal molecules 90 is polymerized and (ii) thereby a layer is formed on the TFT substrate 41 and the counter substrate 42, specifically, on the first alignment layers 57 provided on the TFT substrate 41 and the counter substrate 42.

This is described specifically below.

Firstly, liquid crystal mixed with a light-polymerized acrylate monomer is sealed between the TFT substrate 41 and the counter substrate 42.

Then, while a voltage is being applied to the pixel electrode 22 (the reflective electrode 22a and the transparent electrode 22b), light to the transmissive region b is shielded by using a mask so that light is irradiated onto the reflective region a only, thereby selectively polymerizing the monomer contained in the reflective region a only. In other words, while a voltage is being applied to the whole of the pixel electrode including the reflective region a and the transmissive region b, light is selectively irradiated onto the reflective region a only.

Thereby, the second alignment layer for the reflective region is formed only in the reflective region a of the first alignment layer surface of each of the TFT substrate 41 and the counter substrate 42.

Further, by controlling the voltage applied during the light irradiation, it is possible to control a pretilt angle of the liquid crystal molecules 90 in the reflective region a. That is, it is possible to obtain different pretilt angles in the reflective region a and the transmissive region b.

In the present embodiment, it is preferable that the voltage applied to the pixel electrode 22 during the polymerization is set to (i) a voltage equal to or higher than a voltage (a black voltage for the transmissive region b) at which a black display is carried out in the transmissive region b, for the purpose of making a pretilt angle of the liquid crystal molecules 90 in the reflective region a larger than that in the transmissive region b, and (ii) a voltage equal to or higher than a voltage at which a retardation of the liquid crystal layer 55 in the reflective region a becomes half a retardation of the liquid crystal layer 55 in the transmissive region b.

One reason for the above is as follows: Since the retardation in the reflective region a is controlled by the pretilt angle of the liquid crystal molecules 90, it is necessary to form an alignment layer (the second alignment layer for the reflective region) in the reflective region a while a voltage at least equal to or higher than the black voltage for the transmissive region b is applied, for the purpose of causing (i) the retardation of the liquid crystal layer 55 in the reflective region a and (ii) that in the transmissive region b to be equalized. That is, in order to display black in the reflective region a with the same voltage as that for the transmissive region b, it is necessary to apply a voltage equal to or higher than the black voltage for the transmissive region b during the polymerization, because a retardation of reflected light in the reflective region a is twice as higher as a retardation of transmitted light in the transmissive region b before the polymerization.

Another reason for the above is as follows: In order to cause (i) the retardation in the reflective region a and (ii) the retardation in the transmissive region b to be substantially equalized, it is preferable that the voltage applied during the polymerization is set to a voltage equal to or higher than a voltage at which the retardation in the reflective region a becomes half the retardation in transmissive region b, because a light path length in the reflective region a is twice as longer as a light path length in the transmissive region b.

Note that the voltage applied during the polymerization is not limited to the above-mentioned voltages, and may be any voltage as long as it gives a pretilt angle allowing, after the polymerization, a black display to be carried out in the reflective region a at the black voltage for the transmissive region b.

That is, because the pretilt angle obtained in the reflective region a after the polymerization may vary depending on a kind and/or an amount of a polymerization component added to the liquid crystal layer 55, polymerization conditions (e.g., in a case of polymerization using ultraviolet rays, an irradiation energy of the ultraviolet rays), and/or the like, it is preferable that the voltage is determined according to liquid crystal display apparatuses individually.

The following describes the polymerization further in detail. For example, assume a case where an alignment layer having a pretilt angle of 7° is used as the first alignment layer. In this case, (i) mixing a monomer serving as a polymerization component with liquid crystal by approximately 0.4 wt % and (ii) irradiating irradiation light having an energy of 72 J while a voltage of 20V or higher is being applied causes the second alignment layer for the reflective region to have a pretilt angle of approximately 37°. Thus, in the reflective region a, a splay alignment having the pretilt angle of approximately 37° is obtained.

This makes it possible to equalize retardations of emitted light (reflected light and transmitted light) in the reflective region a and the transmissive region b, thereby realizing the liquid crystal display apparatus 1 which does not have a resin step 154, has a single-gap configuration (in which the thickness of the liquid crystal layer 55 in the reflective region a is almost the same as that in the transmissive region b), and carries out substantially the same display in the reflective region a and in the transmissive region b.

FIG. 8 shows a pretilt angle with respect to (i) a polymerization voltage, which is the voltage applied, and (ii) an irradiation light energy. FIG. 8 is a view illustrating a relationship between the polymerization voltage and the pretilt angle (polymerization voltage dependency of the pretilt angle) in First Embodiment of the present invention.

In the liquid crystal display element 1 of the present embodiment, the reflective region a is provided in a region along the gate bus line 31 connected with the TFT provided on the pixel 11. Specifically, the pixel 11 is divided, along a direction parallel to the gate bus line 31, into two regions having almost the same size. Then, out of the two regions, the one closer to the gate bus line 31 is the reflective region a, and the other is the transmissive region b.

As described above, in the present embodiment, thanks to the second alignment layer 58a for the reflective region formed by the polymer which has been light-polymerized, even while no voltage is applied, the liquid crystal molecules 90 contained in the liquid crystal layer 55 in the reflective region a are aligned in the splay alignment having the pretilt angle larger than that in the transmissive region b. Further, as described above, the pretilt angle in the reflective region a is set to a value allowing an effective retardation of the liquid crystal layer 55 in the reflective region a to be equalized with that in the transmissive region b.

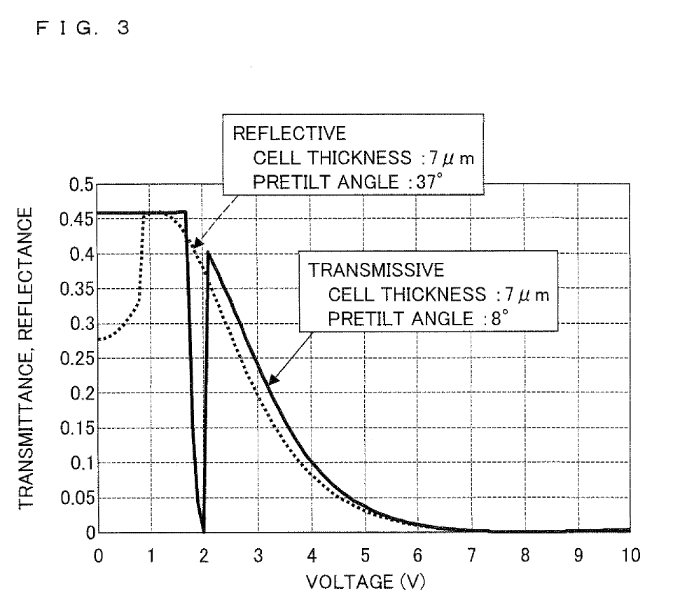

That is, it is possible to control the retardations in the reflective region a and the transmissive region b by the pretilt angle. This allows (i) the retardation of the liquid crystal layer 55 in the reflective region a and (ii) that in the transmissive region b to be equalized, without having a multi-gap configuration (i.e., a configuration in which the resin step 154 or the like is provided for the purpose of making the thickness of the liquid crystal layer 55 in the reflective region a different from that in the transmissive region b). In other words, as illustrated in FIG. 3, it is possible to have the same electro-optical property in the reflective region a and the transmissive region b, without having the multi-gap configuration. Consequently, it is possible to realize the liquid crystal display apparatus 1 with the single-gap configuration. FIG. 3 is a view illustrating an electro-optical property of the liquid crystal display apparatus 1 of the present embodiment.

Next, the following describes an inverse transition. In this context, the inverse transition means a transition from the bend alignment to the splay alignment.

As described above, the inverse transition is apt to occur from an area around the pixel 11, for example, a corner of the pixel 11 or in the vicinity of the gate bus line 31.

In view of this point, as illustrated in FIG. 1, in the liquid crystal display apparatus 1 of the present embodiment, the reflective region a having a larger pretilt angle than that of the transmissive region b is provided in the corner of the pixel 11 and in the vicinity of the gate bus line 31. This allows a voltage at which the inverse transition occurs to be shifted to a lower voltage, thereby suppressing occurrence of the inverse transition.

That is, in a case of the liquid crystal display apparatus 1 employing a normally white mode, a voltage to be applied needs to be decreased for the purpose of carrying out a more perfect white display, as described above. However, decreasing the voltage is likely to cause the inverse transition. In view of this point, in the liquid crystal display apparatus 1 of the present embodiment, the reflective region a having the larger pretilt angle is positioned in an area where the inverse transition is apt to occur. This allows the voltage applied to the liquid crystal layer 55 for the purpose of carrying out a white display to be decreased. Thus, it is possible to carry out a white display of a high transmittance, while suppressing occurrence of the inverse transition.

Further, the reflective region a of the present embodiment serves as a nucleus for the splay-bend transition. That is, since the reflective region a of the present embodiment has the larger pretilt angle, the splay-bend transition occurs in the reflective region a at a voltage lower than a voltage causing the splay-bend transition in the transmissive region b having the smaller pretilt angle, and the bend alignment occurred in the reflective region a spreads into the transmissive region b. Thus, since the reflective region a of the present embodiment is a region, provided inside the pixel 11, in which the bend transition occurs at a low voltage, the reflective region a is also effective as the nucleus (alignment transition nucleus) for the splay-bend transition.

Explanations of the inverse transition made so far are based on normally white. However, also in a case of normally black, the inverse transition occurs in the same manner. That is, in the normally black, as well as the description above, a voltage applied to a liquid crystal layer needs to be reduced to near a critical voltage (Vcr) between the splay alignment and the bend alignment, for the purpose of carrying out a black display having a low transmittance.

### Second Embodiment

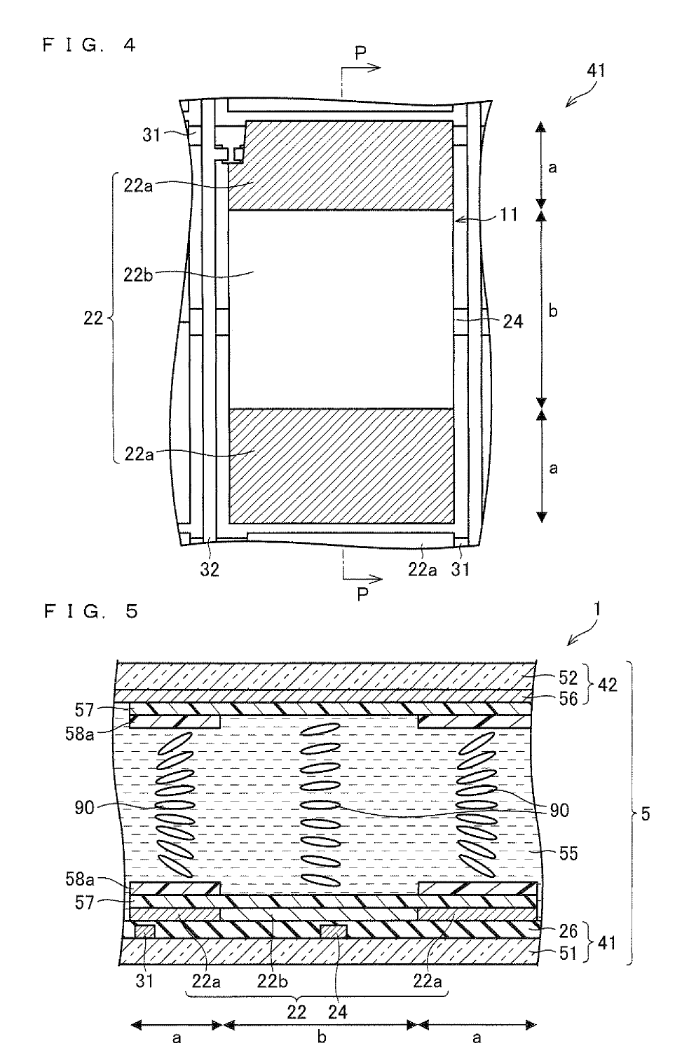

Next, the following describes Second Embodiment of the present invention with reference to FIG. 4 and FIG. 5. FIG. 4 is a view schematically illustrating a configuration of a liquid crystal display apparatus 1 of Second Embodiment. FIG. 5 is a cross-section view schematically illustrating a cross-section configuration of a liquid crystal panel 5 of the liquid crystal display apparatus 1 viewed in a case where the liquid crystal display apparatus 1 is cut along a line corresponding to the P-P line in FIG. 4, and illustrates the cross-section configuration of the liquid crystal panel 5 and an alignment of liquid crystal molecules 90.

Except for a configuration described in the present embodiment, the present embodiment has the same configuration as that of First Embodiment. For convenience of explanation, members having the same functions as those explained in drawings of First Embodiment are given the same signs as First Embodiment, and explanations thereof are omitted here.

An arrangement of a reflective region a and a transmissive region b in a pixel 11 of the liquid crystal display apparatus 1 of the present embodiment is different from that of the liquid crystal display apparatus 1 of First Embodiment. In the liquid crystal display apparatus 1 of First Embodiment, the pixel 11 is divided into two regions, the reflective region a and the transmissive region b, in the vicinity of a center of the pixel 11. On the other hand, in the liquid crystal display element 1 of the present embodiment, the pixel 11 is divided into three regions. Out of the three regions, two regions are reflective regions a, and remaining one region is a transmissive region b. The transmissive region b is sandwiched between the two reflective regions a.

One of the reflective regions a is provided along a gate bus line 31 connected with a TFT provided on the subject pixel 11, and the other one of the reflective regions a is provided along a gate bus line 31 connected with a TFT provided on a pixel 11 adjacent to the subject pixel 11. Thus, the reflective regions a are provided at the two positions substantially in parallel. With this arrangement, two alignment transition nucleuses are provided in the pixel 11. This reduces the time which it takes, in the splay-bend transition, to cause the whole surface of the liquid crystal layer 55 in the pixel 11 to become the bend alignment. Further, this suppresses the inverse transition occurred from the gate bus lines respectively provided along an upper side and a lower side of the pixel 11 (the gate bus line 31 connected with the TFT provided on the subject pixel 11 and the gate bus line 31 connected with the TFT provided on the pixel 11 adjacent to the subject pixel 11). This effect of suppressing occurrence of the inverse transition is greater than that of First Embodiment, because the reflective regions a are provided in the vicinity of the two gate bus lines 31 which are adjacent to the subject pixel 11.

### Third Embodiment

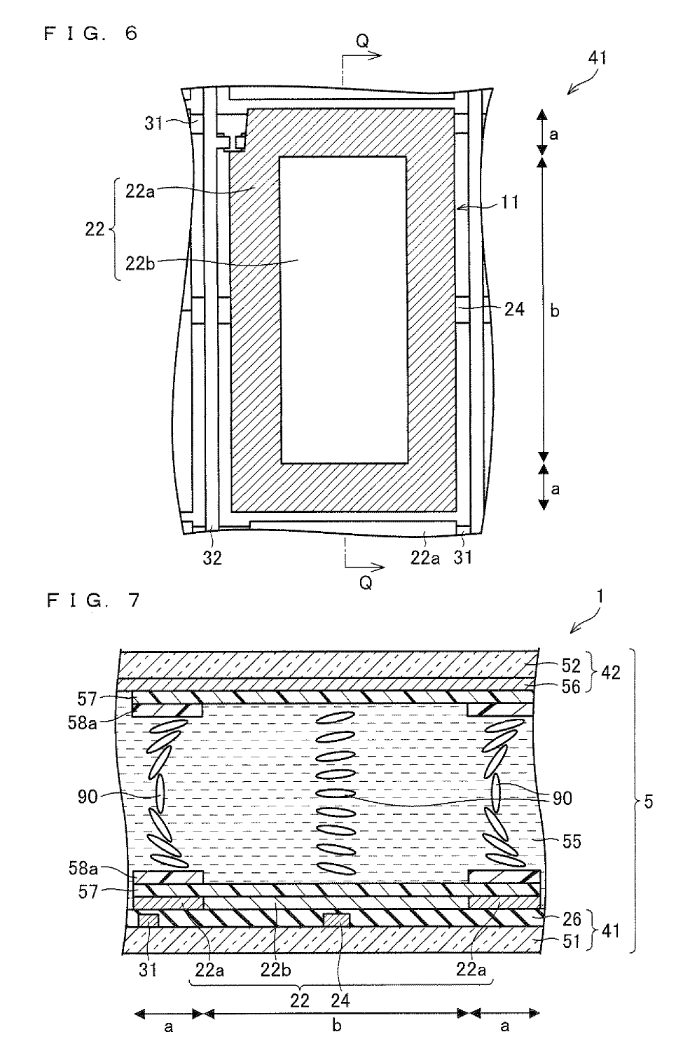

Next, the following describes Third Embodiment of the present invention with reference to FIG. 6. FIG. 6 is a view schematically illustrating a configuration of a liquid crystal display apparatus 1 of Third Embodiment.

Except for a configuration described in the present embodiment, the present embodiment has the same configuration as those of the foregoing embodiments. For convenience of explanation, members having the same functions as those explained in drawings of the foregoing embodiments are given the same signs as the foregoing embodiments, and explanations thereof are omitted here.

An arrangement of a reflective region a and a transmissive region b in a pixel 11 of the liquid crystal display apparatus 1 of the present embodiment is different from that of the liquid crystal display apparatus 1 of First Embodiment. In the liquid crystal display apparatus 1 of First Embodiment, the pixel 11 is divided into two regions, the reflective region a and the transmissive region b, in the vicinity of a center of the pixel 11. On the other hand, in the liquid crystal display element 1 of the present embodiment, although the pixel 11 is divided into two regions as well as in the liquid crystal display apparatus 1 of First Embodiment, the arrangement thereof is different from that of the liquid crystal display apparatus 1 of First Embodiment. In the liquid crystal display element 1 of the present embodiment, a reflective region a is formed such that it surrounds a transmissive region b. Specifically, the transmissive region b shaped in a rectangle is provided at a substantially center of the pixel 11. Further, the reflective region a in a substantially frame shape is provided such that it surrounds the transmissive region b, along all sides (four sides) of the pixel 11. That is, the reflective region a is provided along (i) a gate bus line 31 and a data bus line 32 for the subject pixel 11 and (ii) a gate bus line 31 and a data bus line 32 for pixels 11 adjacent to the subject pixel 11.

In the liquid crystal display element 1 of the present embodiment, the reflective region a is provided in the vicinity of the four sides of the pixel 11, as described above. This further reduces the time which it takes, in the splay-bend transition, to spread the bend alignment over liquid crystal molecules in the pixel 11 in four directions and to cause the whole surface of the pixel 11 to become the bend alignment. Further, since the reflective region a, in which the inverse transition is difficult to occur, is provided along the periphery i.e., all of the four sides of the pixel 11, it is possible to more surely suppress the inverse transition occurred from a corner or peripheral areas of the pixel 11.

### Fourth Embodiment

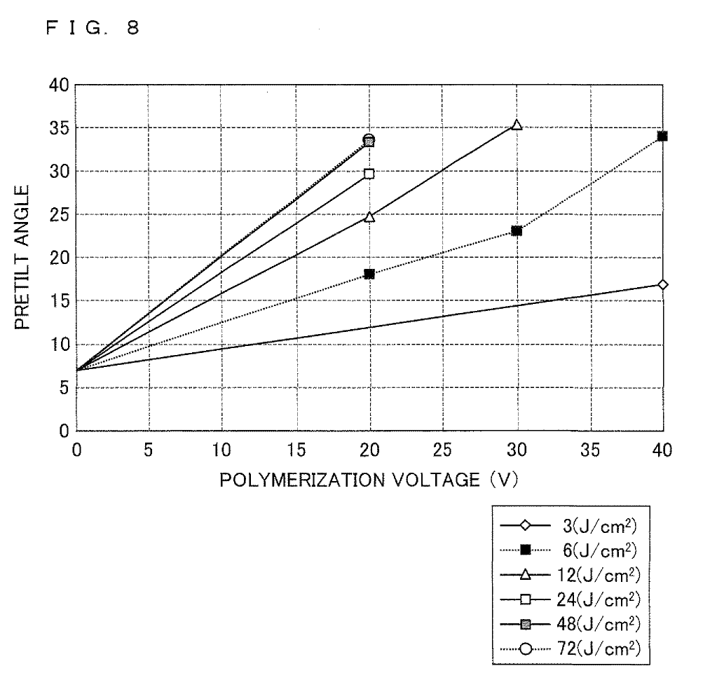

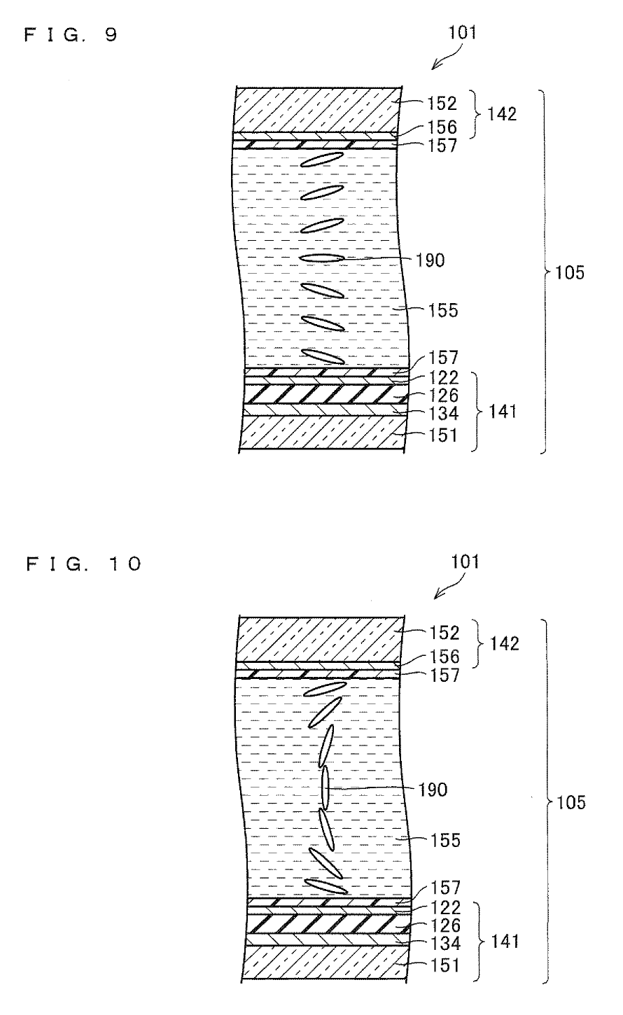

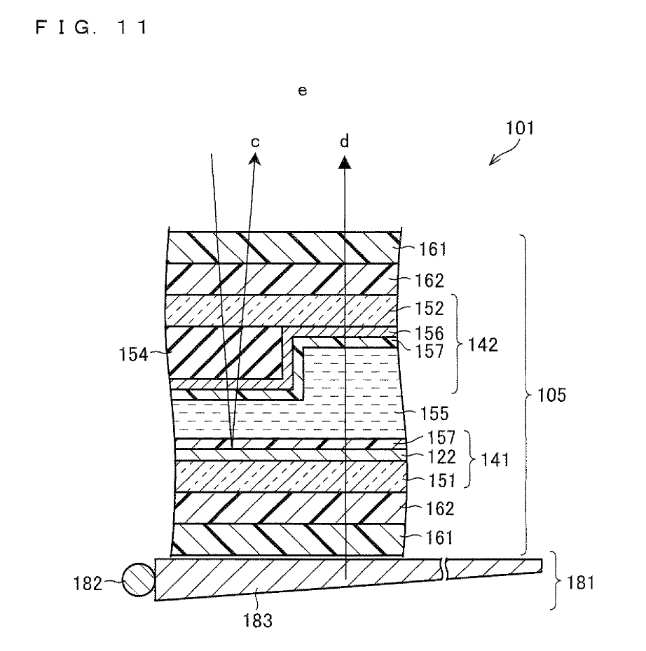

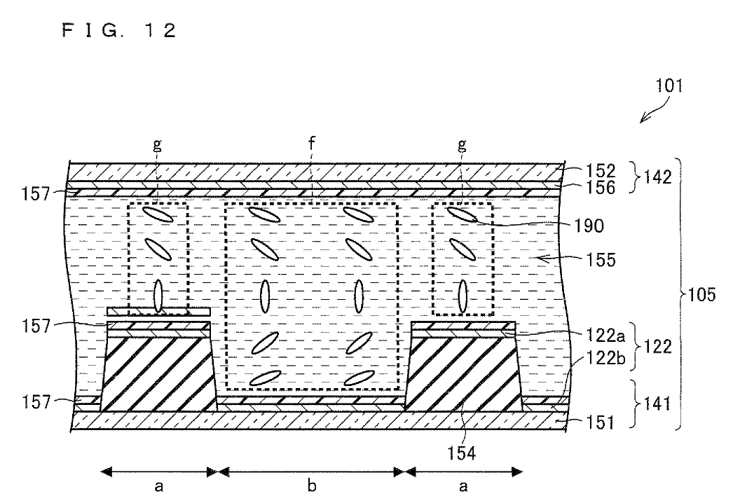

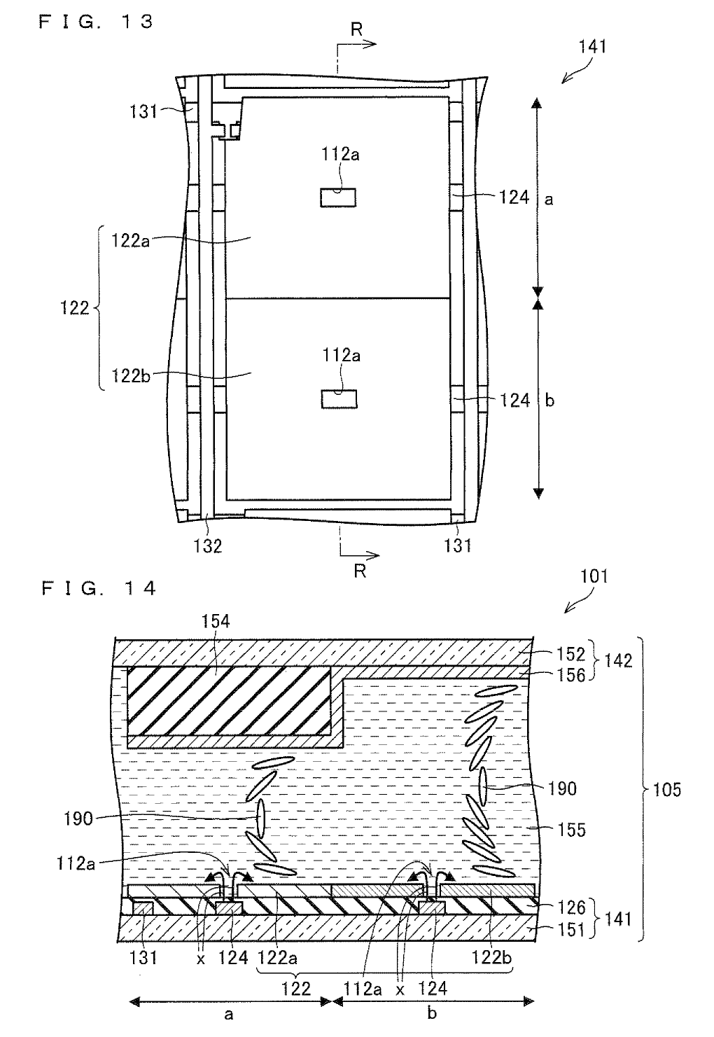

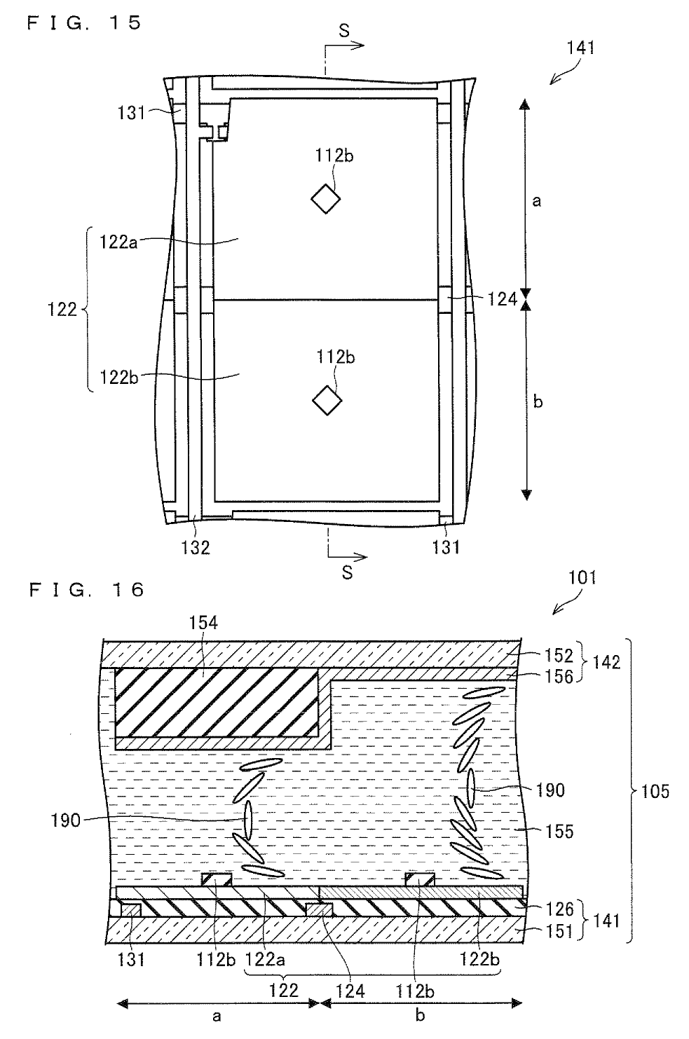

Next, the following describes, with reference to FIG. 7, a liquid crystal display apparatus according to Fourth Embodiment of the present invention. FIG. 7 is a cross-section view schematically illustrating a cross-section configuration of a liquid crystal panel 5 of a liquid crystal display apparatus 1 viewed in a case where the liquid crystal display apparatus 1 is cut along a line corresponding to the Q-Q line in FIG. 6, and illustrates the cross-section configuration of the liquid crystal panel 5 and an alignment of liquid crystal molecules 90.

Except for a configuration described in the present embodiment, the present embodiment has the same configuration as those of the foregoing embodiments. For convenience of explanation, members having the same functions as those explained in drawings of the foregoing embodiments are given the same signs as the foregoing embodiments, and explanations thereof are omitted here.

The liquid crystal display apparatus 1 of the present embodiment has the same configuration as that of the liquid crystal display apparatus 1 of Third Embodiment. That is, the arrangement of the reflective region a and the transmissive region b in the pixel 11 and the like are the same in the liquid crystal display apparatus 1 of the present embodiment and the liquid crystal display element 1 of Third Embodiment.

A difference between the liquid crystal display apparatus 1 of the present embodiment and the liquid crystal display apparatus 1 of Third Embodiment is as follows: In the liquid crystal display element 1 of Third Embodiment, the alignment of the liquid crystal molecules 90 in the reflective region a on which the second alignment layer 58a for the reflective region has been formed is the splay alignment. On the other hand, in the liquid crystal display element 1 of the present embodiment, the alignment of the liquid crystal molecules 90 in the reflective region a on which a second alignment layer 58a for a reflective region has been formed is the bend alignment while no voltage is applied. This is described below.

The above-described difference regarding the alignment results from the fact that pretilt angles are different between the second alignment layers 58a for the reflective regions. In the second alignment layer 58a for the reflective region of the present embodiment, the pretilt angle is set so that it causes the liquid crystal molecules 90 to be aligned in the bend alignment while no voltage is applied.

Specifically, in a case where a first alignment layer having a pretilt angle of 7° is used, (i) mixing a monomer serving as a polymerization component by approximately 0.4 wt % and (ii) irradiating irradiation light having an energy of 72 J while a voltage of 30V or higher is being applied causes the second alignment layer 58a for the reflective region to have a pretilt angle of approximately 45°. A pretilt angle of approximately 45° or more causes the liquid crystal molecules 90 to be aligned in the bend alignment. Therefore, by forming the second alignment layer 58a for the reflective region in accordance with the foregoing conditions, it is possible to cause the alignment of the liquid crystal molecules 90 in the reflective region a to become the bend alignment while no voltage is applied.

Further, by causing the reflective region a to become the bend alignment, the bend alignment spreads into the transmissive region b more smoothly in a case where the splay-bend alignment transition is carried out with respect to the liquid crystal molecules 90 in the transmissive region b. This makes it possible to cause the whole of the pixel 11 to transition to the bend alignment more surely in a shorter period of time.

Furthermore, as for occurrence of the inverse transition, in the present embodiment, because the liquid crystal molecules 90 in the reflective region a are aligned in the bend alignment while no voltage is applied, it is possible to suppress the inverse transition occurred from the periphery of the pixel 11 and thereby to suppress occurrence of the inverse transition in the pixel 11 more surely.

In the foregoing embodiments, the monomer to be used as the polymerization component is not particularly limited to any specific kind. The monomer to be used as the polymerization component may be not only the light-polymerized acrylate monomer, but also a monomer expressed by A-C-(E-D)n-B (here, “A” and “B” denote a functional group such as an acrylate group, a methacrylate group, a vinyl group, a vinyloxy group, or an epoxy group; “C” and “D” denote a cyclic structure such as 1,4-phenylene group or a naphthalene-2,6-diyl group; “E” denotes —COO— group, —OCO— group, or a single bond; “n” denotes 0, 1, or 2), for example.

As described above, the foregoing alignment layer is not limited to a film type one, and may also be a discrete polymer layer formed in a case where polymerization is carried out by using a vertical alignment layer material, for example.

The pretilt angle means an angle made by a liquid crystal molecule and a substrate. There are various methods for measuring the pretilt angle. Examples of the method encompass a method in which a retardation is measured and a pretilt angle is calculated based on the value obtained by the measurement. Specifically, firstly, a retardation, and, among elements determining the retardation (a pretilt angle, a thickness of a liquid crystal layer (a cell thickness), and a birefringence Δn), the thickness of the liquid crystal layer and the birefringence Δn are measured. Here, as a method for measuring the thickness of the liquid crystal layer, there is a method for measuring a height and a diameter of a spacer which determines the thickness of the liquid crystal panel. Specifically, for example, in a case where a photo spacer is used, a height of the photo spacer is measured by a profilometer or the like; in a case where a bead spacer is used, a diameter of the bead spacer is measured. As a method for measuring the birefringence Δn, there is a method in which liquid crystal is taken out alone from a liquid crystal panel and a refractive index thereof is measured. Then, based on the retardation, the thickness of the liquid crystal layer, and the birefringence Δn, the pretilt angle is calculated.

In the foregoing description, the method for forming a polymer by polymerizing the monomer serving as the polymerization component is used as the method for making the pretilt angle in the reflective region a larger than that in the transmissive region b. However, the present invention is not limited to this, and may use any method as far as the method is capable of providing an effect substantially the same as those of the foregoing embodiments.

For example, an alignment layer having different pretilt angles in a reflective region a and a transmissive region b may be formed. A specific method for this may be such that different alignment layer materials are used for the reflective region a and the transmissive region b, or the reflective region a and the transmissive region b is subjected to an alignment treatment such as a rubbing treatment under different conditions.

In the description above, the reflective region a is provided with the second alignment layer 58a for the reflective region, the second alignment layer 58a for the reflective region having the pretilt angle larger than that in the transmissive region b. However, instead of this, the transmissive region b may be provided with a second alignment layer for a transmissive region, the second alignment layer for the transmissive region having the pretilt angle smaller than that in the reflective region a.

Furthermore, a first alignment layer may be provided with a second alignment layer (a second alignment layer for a reflective region and a second alignment layer for a transmissive region) both in a reflective region a and a transmissive region b, and the second alignment layer for the reflective region may be made so as to have a larger pretilt angle than that of the second alignment layer for the transmissive region.

Moreover, in such a configuration that a reflective region a and a transmissive region b are allowed to be driven individually, polymerization may be carried out by subjecting the whole of a pixel to light irradiation or heating while different voltages are being applied to the reflective region a and the transmissive region b (e.g., while a high voltage is being applied to the reflective region a), instead of carrying out the polymerization by polymerizing the polymer while masking either one of the reflective region a and the transmissive region b.

Described above is about the OCB mode. However, a transflective liquid crystal display apparatus according to the present invention is not limited to the OCB mode, and may also be suitably used with other modes such as a TN (Twisted Nematic) mode.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A liquid crystal display apparatus according to the present invention is capable of suppressing an increase in a manufacturing cost and is capable of similar display in a reflective region and a transmissive region, and is suitable for a use requiring low power consumption, for example, a mobile phone and a portable television.

1. A liquid crystal display apparatus, comprising:
a pair of substrates facing each other; and
a liquid crystal layer sandwiched between the pair of substrates,
the liquid crystal display apparatus having a reflective region and a transmissive region in each pixel, so as to be capable of display in a transmissive mode and a reflective mode,
a thickness of the liquid crystal layer in the reflective region being 90% or more but 110% or less of a thickness of the liquid crystal layer in the transmissive region, and
a pretilt angle of liquid crystal molecules contained in the liquid crystal layer in the reflective region being larger than a pretilt angle of liquid crystal molecules contained in the liquid crystal layer in the transmissive region.

2. The liquid crystal display apparatus as set forth in claim 1, wherein:
the thickness of the liquid crystal layer in the reflective region is the same as the thickness of the liquid crystal layer in the transmissive region.

3. The liquid crystal display apparatus as set forth in claim 1, wherein:
a retardation of the liquid crystal layer in the reflective region is 90% or more but 100% or less of a retardation of the liquid crystal layer in the transmissive region.

4. The liquid crystal display apparatus as set forth in claim 3, wherein:
the retardation of the liquid crystal layer in the reflective region is the same as the retardation of the liquid crystal layer in the transmissive region.

5. The liquid crystal display apparatus as set forth in claim 1, wherein:
each of the pair of substrates is provided with an alignment layer on at least part of a surface of said each of the pair of substrates which surface is in contact with the liquid crystal layer, the alignment layer controlling an alignment of the liquid crystal molecules contained in the liquid crystal layer; and
the alignment layer is formed, by polymerizing a polymerization component contained in the liquid crystal layer while a voltage is being applied to the liquid crystal layer.

6. The liquid crystal display apparatus as set forth in claim 5, wherein:
the alignment layer formed by polymerizing the polymerization component is provided in the reflective region only.

7. The liquid crystal display apparatus as set forth in claim 6, wherein:
during polymerizing of the alignment layer, the voltage applied to the liquid crystal layer in the reflective region is equal to or higher than an ON-voltage applied to the liquid crystal layer in the transmissive region, the ON-voltage being applied while display is actually carried out,

8. The liquid crystal display apparatus as set forth in claim 1, wherein:
the liquid crystal molecules contained in the liquid crystal layer in the transmissive region and the reflective region are transitioned from a splay alignment to a bend alignment in response to a voltage applied to the liquid crystal layer.

9. (canceled)

10. The liquid crystal display apparatus as set forth in claim 1, wherein:
the liquid crystal molecules contained in the liquid crystal layer in the reflective region are aligned in a bend alignment while no voltage is applied to the liquid crystal layer; and
the liquid crystal molecules contained in the liquid crystal layer in the transmissive region are transitioned from a splay alignment to the bend alignment in response to a voltage applied to the liquid crystal layer.

11. (canceled)

12. The liquid crystal display apparatus as set forth in claim 1, wherein:
one of the pair of substrates is provided with a transistor element, one for said each pixel, for switching said each pixel, and is provided with a gate bus line for controlling the transistor element; and
the reflective region in said each pixel is provided along the gate bus line for controlling the transistor element provided for said each pixel.

13. (canceled)

14. (canceled)

15. (canceled)

16. The liquid crystal display apparatus as set forth in claim 12, wherein:
said each pixel is shaped in a rectangle;
the gate bus line is parallel to two sides of said each pixel shaped in the rectangle, the two sides being opposed to each other; and
the reflective region in said each pixel is provided along at least the two sides parallel to the gate bus line, out of four sides of said each pixel shaped in the rectangle.

17. (canceled)

18. (canceled)

19. (canceled)

20. The liquid crystal display apparatus as set forth in claim 1, wherein:
said each pixel is shaped in a rectangle; and
the reflective region, shaped in a frame, is provided along four sides of said each pixel shaped in the rectangle.

21. (canceled)

22. (canceled)

23. (canceled)

24. A method of manufacturing a liquid crystal display apparatus,
said apparatus including a pair of substrates facing each other and a liquid crystal layer sandwiched between the pair of substrates,
said apparatus having a reflective region and a transmissive region in each pixel, so as to be capable of display in a transmissive mode and a reflective mode,
a thickness of the liquid crystal layer in the reflective region being 90% or more but 110% or less of a thickness of the liquid crystal layer in the transmissive layer, and
said method comprising the step of:
polymerizing a polymerization component, among polymerization components added to the liquid crystal layer, added to the liquid crystal layer in the reflective region while a voltage is being applied to the liquid crystal layer so that a pretilt angle of liquid crystal molecules contained in the liquid crystal layer in the reflective region is larger than a pretilt angle of liquid crystal molecules contained in the liquid crystal layer in the transmissive region.
